(19) United States
(12) Patent Application Publication
(10) Pub. No.: US 2025/0001331 A1
(43) Pub. Date: Jan. 2, 2025

(54) FILTRATION DEVICE, IN PARTICULAR FOR A COOLING CIRCUIT

(71) Applicant: HUTCHINSON, PARIS (FR)

(72) Inventor: Damien GILLET, Château Renard (FR)

(21) Appl. No.: 18/758,374

(22) Filed: Jun. 28, 2024

(30) Foreign Application Priority Data
Jun. 30, 2023 (FR) 2306989

(51) Int. Cl. B01D 29/23; B01D 35/02; F01P 11/04

(52) U.S. Cl. CPC B01D 29/23; B01D 35/02; F01P 11/04

(57) ABSTRACT

A filtration device including a tubular connector comprising at least one cooling fluid inlet and at least one outlet, a particulate filter mounted in said connector and extending into the connector from the inlet, this filter having a generally elongate shape and comprising a first open longitudinal end located on the side of the inlet and a second closed longitudinal end located inside the connector, this filter comprising a filter mesh extending around and along a longitudinal axis of the filter, and an overmoulded body, the filter being removably mounted in said connector and at the second end having a bottom wall which converges towards the longitudinal axis and towards the first longitudinal end.

### TECHNICAL FIELD OF THE INVENTION

The invention relates to the field of filtration devices, in particular for cooling circuits.

### TECHNICAL BACKGROUND

The prior art is illustrated in the document EP-A1-4098345.

The motor vehicle engines, for example, are equipped with a cooling circuit that is essential to their smooth operation. The cooling circuit keeps the engine at a lower operating temperature than the maximum recommended temperature and prevents the engine from overheating.

Typically, an engine cooling circuit comprises pipes for the circulation of a cooling fluid from a source of cooling fluid to the engine. During the service life of the engine, particles can accumulate in the pipes until they are blocked and prevent the passage of the cooling fluid. The accumulation of these particles can cause irreversible damage to the engine or the members of the cooling circuit.

In order to prevent the accumulation of these particles, it has been proposed to equip cooling circuits with filtration devices comprising particulate filters. However, the particulate filters on offer are bulky and not easy to integrate into engines. In addition, the storage and transport of particulate filters is particularly restrictive and the manufacturing method for such filters is complex.

As a result, it is common practice not to equip particulate filters to cooling circuits, which tend to impair the proper operation and integrity of the engine. The document US-A1-2020/0054973 describes a filtration device for a fuel cell engine cooling circuit. The filtration device comprises a tubular connector comprising at least one cooling fluid inlet and at least an outlet of this cooling fluid, and a particulate filter mounted in the connector and extending into the connector from the inlet of the connector.

The filter has a generally elongated shape and comprises a first open longitudinal end located on the inlet side and a second closed longitudinal end located inside the connector. The filter comprises a filter mesh extending around and along a longitudinal axis of the filter, and a body overmolded onto the mesh.

According to this document, the particulate filter is attached to the connector by welding. This type of fixing the filter system has its drawbacks. The welding method is long, costly and complex. It is also an irreversible fixing means. If the filter mesh wears out, for example, or if clogging occurs due to the accumulation of particles in the filter, it is necessary to dismantle the entire filtration device, i.e. remove the connector of the cooling circuit and replace it with a new assembly formed by a connector and a filter.

In addition, according to this document, the second end of the filter has a funnel for collecting and discharging the particles. Such a funnel-shaped configuration of the second end of the filter creates disturbances in the flow of the cooling fluid and therefore pressure losses in the cooling circuit which can be detrimental to the performances of the engine.

Consequently, there is a need to provide a filtration device for a cooling circuit, which limits pressure losses in the cooling circuit and which is easy to implement, inexpensive and easy to maintain.

### SUMMARY OF THE INVENTION

To this end, the invention proposes a filtration device, in particular for a cooling circuit, the filtration device comprising:
a tubular connector comprising at least one cooling fluid inlet and at least an outlet of this cooling fluid,
a particulate filter mounted in said connector and extending into the connector from said inlet, the filter having a generally elongate shape and comprising a first open longitudinal end located on the side of said inlet and a second closed longitudinal end located within the connector, this filter comprising a filter mesh extending around and along a longitudinal axis of the filter, and an overmolded body.

The filtration device is remarkable in that the filter is removably mounted in said connector and in that said second end has a bottom wall which converges towards the longitudinal axis and towards said first longitudinal end.

According to the invention, the filter is removably mounted in the connector. This removable connection makes it easier to mount and dismount the filter in the connector. The installation of the filtration device and its maintenance are made easy.

In addition, according to the invention, the bottom wall of the second end of the filter converges towards the longitudinal axis and towards the first end, as opposed to the funnel configuration of the prior art. This characteristic of the invention allows to guide the cooling fluid flowing in the filter to the filter mesh and thus to promote its flow in the cooling circuit, downstream of the filtration device. Compared with an annular or funnel-shaped bottom wall, the bottom wall according to the invention allows flow disturbances in the connector to be reduced, and thus allows pressure losses in the cooling circuit to be reduced.

Thanks to the invention's filtration device, it is therefore possible to easily mount and dismount the filter and ensure the flow of the cooling fluid in the cooling circuit without significant pressure losses.

The invention may comprise one or more of the following characteristics, taken alone or in combination with each other:
the cooling circuit is a cooling circuit of an engine or fuel cell,
the bottom wall comprises a conical or frustoconical surface which is located inside the filter and which has an apex centered on the longitudinal axis,
said conical or frustoconical surface has a generatrix forming an angle α with the longitudinal axis of between 10° and 45°,
the first longitudinal end has a first diameter and said second longitudinal end has a second diameter, the first diameter being greater than the second diameter, preferably from 1.5 times to four times greater than the second diameter,
the bottom wall has a longitudinal dimension along said longitudinal axis, which represents between 2% and 20%, and preferably between 5% and 10%, of a length of the filter along this longitudinal axis,
the filter comprises a frustoconical filtration wall at which the filter mesh is located, the bottom wall being connected to this filtration wall by an annular rim located at the second longitudinal end of the filter,
the bottom wall defines, outside the filter, a recess which is centered on said longitudinal axis and which is surrounded by said annular rim,
the first longitudinal end has an external annular shoulder bearing axially on an annular edge of the inlet of the connector,
the filter is snap-fitted into said connector,
the first longitudinal end has at its external periphery at least one fixing tab, and the connector has at least one opening into which the tab is snap-fitted,
the body comprises longitudinal ribs, advantageously annular ribs overmolded onto the filter mesh and which extend around the longitudinal axis and connected to said longitudinal ribs,
the number of tabs is equal to the number of longitudinal ribs and the tabs are axially aligned with the longitudinal ribs or are located on these longitudinal ribs,
the filter has a length such that it extends over more than 80% of the length of the connector,
the filter mesh and the body comprise a polymeric material, advantageously identical and chosen for example from polyamides,
the filter mesh comprises a textile, preferably woven,
the filter mesh has a filtration surface area of between 60% and 95%, preferably between 70% and 80% of a total external surface area of the filter,
the connector is T-shaped and has first and second coaxial pipes and a third intermediate pipe which extends perpendicularly to the common axis of the first and second pipes,
the internal diameter of the first and second pipes is, for example, 1.5 to four times greater than the internal diameter of the third pipe, in particular twice as great as the internal diameter of the third pipe,
the connector comprises between three and ten openings, or more than ten openings,
the internal diameter of the outer annular shoulder of the first longitudinal end is equal to the internal diameter of the annular edge of the inlet of the connector,
the filter mesh has filtration pores,
the pores have a size in the micrometre range, for example between 10 μm and 500 μm,
the filter mesh is free of fillers comprising fibres,
the filter mesh comprises a textile, preferably of the woven type,
the textile comprises yarns preferably having an average diameter of between 100 μm and 2000 μm,
the apex of the conical surface of the bottom wall is pointed,
the length of the conical or frustoconical surface of the bottom wall is at least equal to the diameter of the base of the conical surface,
the bottom wall and the filtration wall form an angle β of between 5° and 45°, the angle β being measured in a plane passing through the longitudinal axis,
the recess located at the second end of the filter comprises at least one material injection point, preferably centered on the longitudinal axis,
the recess has a frustoconical surface, one end of which, having a smaller diameter, is connected to a surface substantially perpendicular to said longitudinal axis,
an end of greater diameter of the frustoconical surface is connected to said rim,
the bottom wall has a varying thickness, measured along the longitudinal axis,
the thickness of the bottom wall is greatest at the level of the longitudinal axis of the filter, and decreases towards the periphery of this bottom wall,
the maximum thickness of the bottom wall is at least 1.5 times greater than the minimum thickness of the bottom wall measured at its periphery,
the longitudinal ribs are located exclusively on the outside of the filter mesh,
the longitudinal ribs extend from the first end to the second end of the filter,
the longitudinal ribs extend between two annular ribs and each have a first end connected to one annular rib and a second end connected to an adjacent annular rib,
the longitudinal ribs and/or ring ribs are moulded onto the filter mesh,
among the longitudinal ribs and the annular ribs, only the annular ribs are overmolded onto the filter mesh,
the longitudinal ribs are fixed to the annular ribs, with a radial space between the filter mesh and each longitudinal rib,
the filter comprises an inlet opposite the second longitudinal end, the inlet having a rounded shape,
the inlet of the filter is formed at the first longitudinal end of the filter,
the inlet is bearing on the connector,
the inlet of the filter is integrally formed with the body of the filter,
the rounding has a radius of between 2 mm and 10 mm, preferably between 3 mm and 5 mm.
invention also relates to a cooling circuit for an engine.

The cooling circuit is remarkable in that it comprises at least one filtration device according to any one of the preceding characteristics.

### BRIEF DESCRIPTION OF THE FIGURES

Further characteristics and advantages will be apparent from the following description of non-limiting embodiments of the invention with reference to the accompanying drawings in which:

FIG. 1 is a schematic representation of a cooling circuit for a motor vehicle engine,

FIG. 2 shows a partial longitudinal section of a filtration device fitted to the circuit shown in FIG. 1,

FIG. 3 is a perspective representation of the filtration device according to the invention, comprising a connector according to the invention and a filter according to a first embodiment,

FIG. 4 is a perspective view of the filter equipped with the filtration device of FIGS. 2 and 3,

FIG. 5 shows a partial longitudinal section of the filter shown in FIG. 4,

FIG. 6 is an enlarged partial longitudinal section view of the inlet of the connector in which the filter is mounted,

FIG. 7 is a perspective view of a filter according to a second embodiment of the invention,

FIG. 8 is a perspective view of a filter according to a third embodiment of the invention,

FIG. 9 is a longitudinal sectional view of the filtration device according to the invention, comprising the connector according to the invention and a filter according to another embodiment,

FIG. 10 is a side view of the filter equipped with the filtration device in FIG. 9,

FIG. 11 is another perspective view of the filter in FIG. 10.

### DETAILED DESCRIPTION OF THE INVENTION

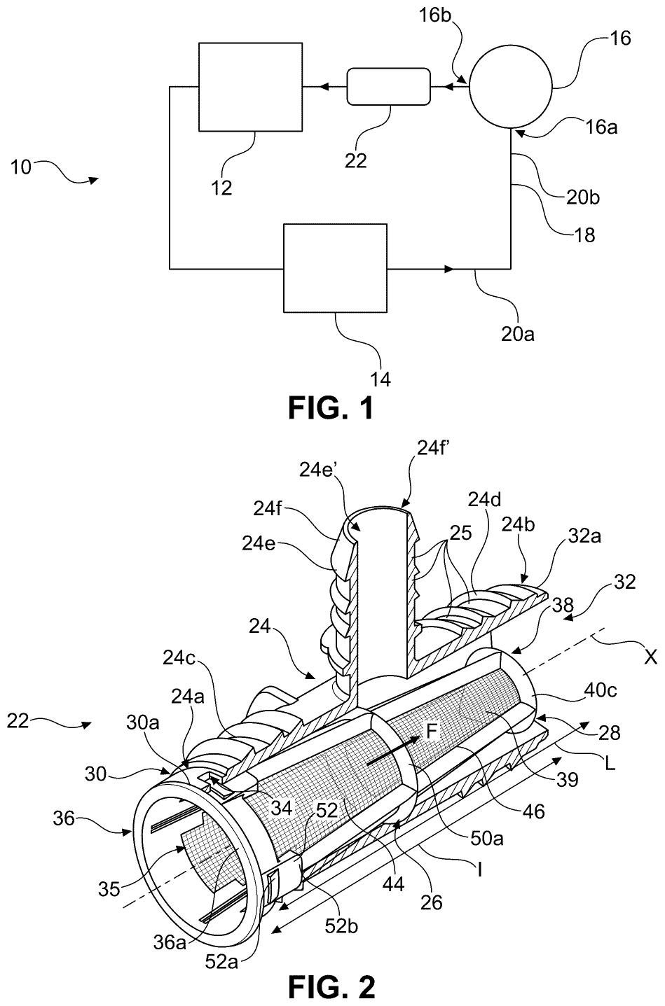

FIG. 1 illustrates, for example, a cooling circuit 10 for an engine 12, in particular of a motor vehicle. However, according to the invention, the cooling circuit 10 could be the cooling circuit of a fuel cell.

The cooling circuit 10 comprises, for example, a source 14 of cooling fluid and a pump 16 arranged between the source 14 and the engine 12. The pump 16 comprises a cooling fluid inlet port 16a connected to the source 14 and a cooling fluid outlet port 16b. The cooling circuit 10 also comprises at least one pipe 18 for the passage of the cooling fluid from the source 14 to the engine 12. The pipe 18 is formed, for example, of a plurality of ducts 20a, 20b connected to each other.

The engine 12 can be thermal, electric or hydrogen-powered, such as a fuel cell.

The cooling fluid is, for example, a liquid, in particular water.

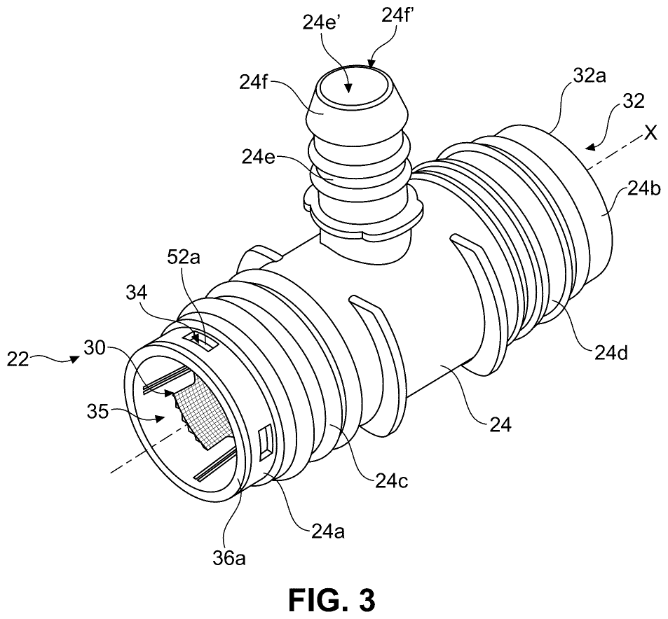

According to the invention, the cooling circuit 10 also comprises a filtration device 22. The filtration device 22 is mounted between the pump 16 and the engine 12, in particular between the outlet port 16b of the pump 16 and the engine 12. Referring to FIG. 2, the filtration device 22 comprises a connector 24 and a particulate filter 26 mounted in the connector 24. With reference to FIGS. 2 and 3, the connector 24 is tubular and has a longitudinal axis X.

In this invention, the terms “longitudinal”, “longitudinally”, “axial”, “axially”, “radial” and “radially” are understood to refer to the longitudinal axis X.

The terms “internal”, “internally”, “inside”, “external”, “externally” and “outside” are understood in relation to the distance from the longitudinal axis X along a radial axis extending perpendicular to the longitudinal axis X.

The terms “upstream” and “downstream” refer to the direction of flow F of the cooling fluid in the filtration device 22 along the longitudinal axis X.

The connector 24 has a tubular body extending longitudinally between first and second longitudinal ends 24a, 24b. It also comprises a first internal passage 28 extending longitudinally between the longitudinal ends 24a, 24b.

The connector 24 comprises at least one cooling fluid inlet 30 and a cooling fluid outlet 32. The inlet 30 is connected, for example, to the output 16b of the pump 16 and the outlet 32 is connected to the engine 12. The inlet and outlet 30, 32 are formed, for example, at the first and second longitudinal ends 24a, 24b respectively. The inlet and outlet 30, 32 each have an annular edge 30a, 32a.

According to one embodiment of the invention, the connector 24 is for example T-shaped. According to this example, the tubular body comprises a first pipe 24c extending longitudinally from the first end 24a, a second pipe 24d extending to the second end 24b and being coaxial with the first pipe 24c. The tubular body comprises an intermediate third pipe 24e which extends perpendicularly to the longitudinal axis X of the first and second pipes 24c, 24d. The third pipe 24e has an auxiliary passage 24e′ of the cooling fluid which opens into the first internal passage 28. The third pipe 24e also has an external radial end 24f on which a second outlet 24f′ of the cooling fluid is formed.

The first, second and third pipes 24c, 24d, 24e each have an internal diameter, the internal diameter of the first and second pipes 24c, 24d advantageously being identical to and greater than the internal diameter of the third pipes 24e. The internal diameter of the first and second pipes 24c, 24d is, for example, 1.5 to four times greater than the internal diameter of the third pipe 24e, in particular twice as great as the internal diameter of the third pipe 24e.

According to an advantageous embodiment of the invention, the connector 24 also has at least one opening 34, and advantageously a plurality of openings 34. The openings 34 are formed in the first end 24a of the connector 24. The openings 34 are evenly distributed around the longitudinal axis X. Their number is, for example, between three and ten, and may be greater than ten. Each opening 34 is polygonal in shape, for example square or rectangular.

The connector 24 is mounted in the cooling circuit 10, for example by press fitting into the ducts 20a, 20b. To this end, the connector 24 comprises, for example, external annular grooves 25 formed, for example, on the first, second and third pipes 24c, 24d, 24e.

The filter 26 is a particulate filter mounted in connector 24. The filter 26 has a generally elongated shape centred on the longitudinal axis X. Preferably, the filter 26 has a length l as measured along the longitudinal axis X greater than or equal to 80% of the length L of the connector 24.

The filter 26 is located in the first passage 28. The filter 26 also has a second internal passage 35 for the circulation of the cooling fluid.

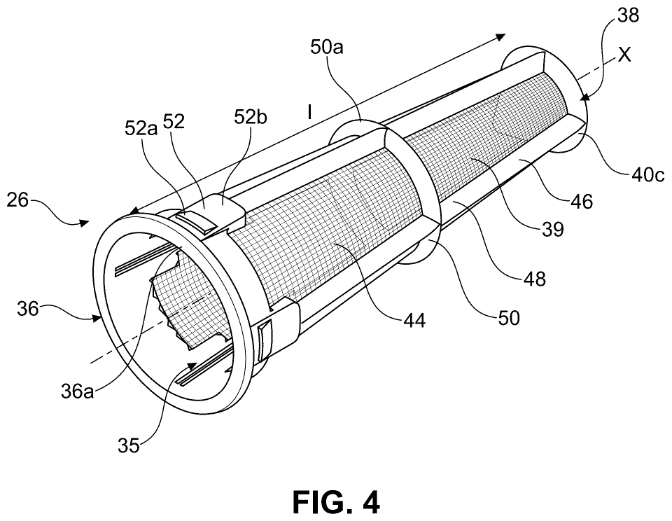

As can be seen more clearly in FIG. 4, the filter 26 extends along the longitudinal axis X between a first longitudinal end 36 which is open and a second longitudinal end 38 which is closed and connected together by, for example, a frustoconical filtration wall 39 centred on the longitudinal axis X.

The first and second longitudinal ends 36, 38 are annular and centred on the longitudinal axis X. They have a first and a second internal diameter respectively. The first internal diameter of the first longitudinal end 36 of the filter 26 is greater than the second internal diameter of the second longitudinal end 38. Preferably, the first diameter is 1.5 times to four times larger, in particular twice as large as the second internal diameter of the second longitudinal end 38.

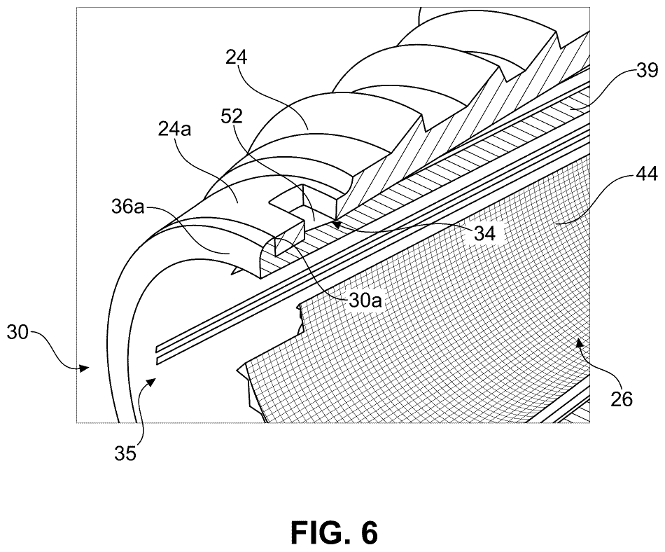

The first longitudinal end 36 is located on the inlet 30 side of the connector 24. Advantageously, the first longitudinal end 36 has an external annular shoulder or lip 36a which bears axially against the annular edge 30a of the inlet 30 of the connector 24. As can be seen more clearly in FIG. 3 or 6, the external diameter of the outer annular shoulder 36a is equal to the external diameter of the annular edge 30a of the inlet 30 of the connector 24. The external annular shoulder 36a is thus axially aligned with the annular edge 30a of the inlet 30 of the connector 24.

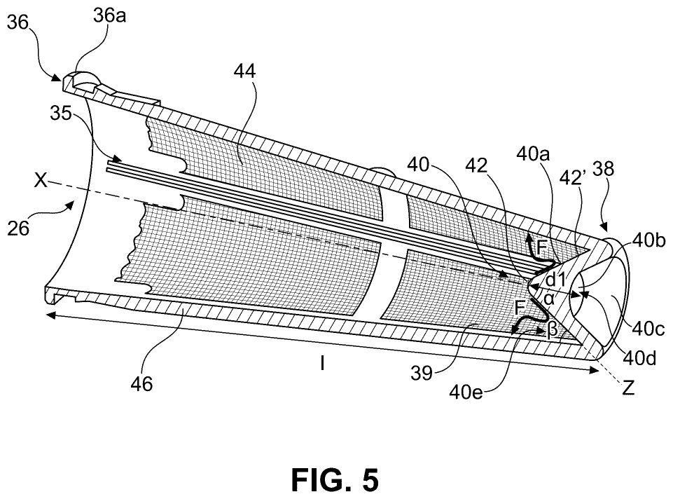

The second longitudinal end 38 is located inside the connector 24, preferably downstream of the third pipe 24e. The second longitudinal end 38 is closed by a bottom wall 40. With reference to FIG. 5, the bottom wall 40 has an upstream surface 40a located inside the filter 26 and a downstream surface 40b perpendicular to the longitudinal axis X and located outside the second internal passage 35.

According to the invention, the bottom wall 40 converges towards the longitudinal axis X and towards the first longitudinal end 36 of the filter 26. The upstream surface 40a is therefore conical or frustoconical and has an apex 42 centered on the longitudinal axis X and located inside the filter 26, in the internal passage 35, and a base 42′ opposite the apex 42.

According to the embodiment of the FIG. 5, the upstream surface 40 is conical. The apex 42 is pointed.

The axial length of the conical or frustoconical upstream surface 40 of the bottom wall 40 is at least equal to the diameter of the base of this surface. The bottom wall 40 has a thickness as measured along the variable longitudinal axis X. This thickness is greatest at the level of the longitudinal axis X of the filter 26 and decreases towards the periphery of the bottom wall 40. Preferably, the bottom wall 40 has a maximum longitudinal dimension d1 as measured along the longitudinal axis X which represents between 2% and 20%, preferably between 5% and 10%, of the length l of the filter 26. This longitudinal dimension d1 is measured along the longitudinal axis X between the apex 42 and the downstream surface 40b. It thus represents the maximum thickness of the bottom wall 40. This maximum thickness is at least 1.5 times greater than the minimum thickness of the bottom wall 40 measured at its periphery.

Preferably, the conical upstream surface 40a has a generatrix Z forming an angle α with the longitudinal axis X of between 10° and 45°. The angle α represents the half angle at the apex of the cone.

The bottom wall 40 is advantageously made of a polymer material chosen, for example, from polyamides. For example, it is overmoulded.

This conical or frustoconical upstream surface 40a guides the flux of cooling fluid F towards the filtration wall 39, as shown by the arrows in FIG. 5. Guiding the flow in this way reduces disturbances to the cooling flux in the cooling circuit 10. The pressure losses in the cooling circuit are therefore limited.

The conical upstream surface 40a with a pointed apex 42 further improves the guidance of the cooling flux F towards the filtration wall 39.

In addition, the advantageous length of the conical or frustoconical upstream surface 40a allows to create a larger guide surface to further improve the guidance of the cooling flux F towards the filtration wall 39.

The bottom wall 40 is connected to the filtration wall 39 by an annular rim 40c located at the second end 38 of the filter 26. Advantageously, the bottom wall 40 and the filtration wall 39 form an angle β of between 5° and 45°, the angle β being measured in a plane passing through the longitudinal axis X. The annular rim 40c is made of a polymer material identical to the material of the bottom wall 40. The annular rim 40 is, for example, overmolded with the bottom wall 40.

The bottom wall 40 also has a recess 40d, also known as a cavity, located outside the internal passage 35. This recess 40d has a frustoconical surface with an upstream end and a downstream end with a diameter greater than the diameter of the upstream end. The smaller diameter upstream end is connected to or formed by the downstream surface 40b of the bottom wall 40, while the larger diameter downstream end is radially delimited by the annular rim 40c. The recess 40d has at least one injection point for a polymer material. Such a recess 40d facilitates the manufacture of the filter 26 by moulding. In fact, the recess 40d constitutes a zone at which a injection point of the polymeric material can be provided during the molding process. With the injection point in this recess 40d, the bottom wall 40 advantageously has no protruding parts that could compromise the safety of the operators during handling and mounting of the filter 26. Moreover, when injecting the polymeric material, the maximum axial thickness of the bottom wall 40 promotes the uniform distribution of the material in the mold and limits the molding defects.

In addition, the recess 40d allows the filter 26 to be reduced in size. In fact, for the same filtration surface, the axial dimension of the filter 26 is reduced thanks to the recess 40d compared to a bottom wall 40 without such a recess 40d.

In addition, the filter 26 comprises a storage space 40e for the particles delimited by the base 42′ of the upstream surface 40a of the bottom wall 40 and radially by the filtration wall 39. The storage space 40e allows particles to accumulate and be stored in the downstream part of the filter 26 without reducing the effective filtration surface area of the filter 26.

The filtration wall 39 is substantially frustoconical in shape. The filtration wall 39 advantageously has an internal diameter which decreases towards the outlet 28 of the connector 24.

The filter 26 comprises a filter mesh 44 and a body 46 overmolded. The filter mesh 44 constitutes the filtration wall 39. It thus extends between the first and second longitudinal ends 36, 38. In particular, the filter mesh 44 extends from the annular shoulder 36a to the annular rim 40c.

The filter mesh 44 has filtration pores for the passage of the cooling fluid while retaining contaminating particles. For example, the pores have a size in the micrometre range, for example between 10 μm and 500 μm.

The filter mesh 44 advantageously has a filtration surface area of between 60% and 95% of the total external surface area of the filter 26, in particular between 70% and 80% of the total external surface area of the filter 26.

The filter mesh 44 comprises a textile, preferably woven, comprising polymer threads. The polymer of the yarns is for example chosen among polyamides, polyolefins such as polypropylene, polyethylene or polyesters.

The threads preferably have an average diameter of between 100 μm and 2000 μm.

Advantageously, the textile of the filter mesh 44 is free of fillers comprising fibres.

According to a first embodiment, the body 46 is overmolded onto the filter mesh 44.

During the overmolding operation of the body 46, the maintenance of the filter mesh 44 is improved thanks to the upstream surface 40a conical or truncated.

The body 46 comprises longitudinal ribs 48 and, advantageously, annular ribs 50 connected to the longitudinal ribs 50. The longitudinal ribs 48 and the annular ribs 50 are overmolded onto the filter mesh 44 according to the filter mesh.

The longitudinal ribs 48 are evenly spaced around the longitudinal axis X.

According to this first embodiment, they also extend from the first longitudinal end 36 to the second longitudinal end 38 of the filter 26.

The longitudinal ribs 48 are preferably located exclusively on the outside of the filter mesh 44 in order to take up the forces associated with the internal pressure. The longitudinal ribs 48 are for example two, three, four or five or more depending on the diameter of the filter 26.

The annular ribs 50 are centred on the longitudinal axis X. They are evenly distributed along the longitudinal axis X. The body 46 has, for example, a first annular rib located on the first longitudinal end 36 and forming the annular shoulder 36a, a second annular rib located on the second longitudinal end 38 and forming the annular rim 40c and, according to this embodiment, a third central annular rib 50a located at an equal distance from the first and second annular ribs.

Advantageously, the bottom wall 40 forms an integral part of the body 46. The body 46 comprises a polymer material, preferably identical to the polymer material of the filter mesh 44. Preferably, the polymer material is chosen from polyamides. The body 46 is formed by overmolding, for example.

The body 46 reinforces the filter mesh 44 against the stresses associated in particular with the internal pressure of the cooling circuit 10.

According to the invention, the filter 26 is removably mounted in the connector 24, preferably snap-fitted. To this end, the filter 26 advantageously comprises at least one fixing tab 52 which snaps into a corresponding slot 34 in the connector 24. Advantageously, the filter 26 comprises a plurality of tabs 52 evenly distributed around the longitudinal axis X. In particular, the filter 26 comprises as many tabs 52 as there are openings 34 and longitudinal ribs 48.

The tabs 52 are formed on the external periphery of the first longitudinal end 36 of the filter. Preferably, the tabs 52 are axially aligned with the longitudinal ribs 48 or located on the longitudinal ribs 48.

Preferably, the tabs 52 are overmolded onto the filter mesh 44. For example, they are formed during the manufacture of the body 46 and thus form an integral part of the body 46.

The tabs 52 are polygonal in shape, preferably substantially rectangular. They each have a lug 52a and a support end 52a enabling the lugs 52a to be inserted into the corresponding openings 34 by pressing the connector 24 onto the tabs 52. The lugs 52a allow the filter 26 to be locked in translation and rotation in the connector 24.

Such a removable connection, preferably snap-fitted, makes it easier to fit and remove the filter 26 in the connector 24. The installation of the filtration device 22 and its maintenance are facilitated.

In addition, the conical configuration of the bottom wall 40 allows the cooling liquid to be guided towards the filtration wall 39 in order to reduce the disturbances to the flux of the cooling fluid in the connector 24 and thus reduce pressure losses in the cooling circuit 10.

Thanks to the filtration device 22 of the invention, it is therefore possible to easily mount and dismount the filter 26, and guarantee the flow of the cooling fluid in the cooling circuit 10 without significant pressure losses.

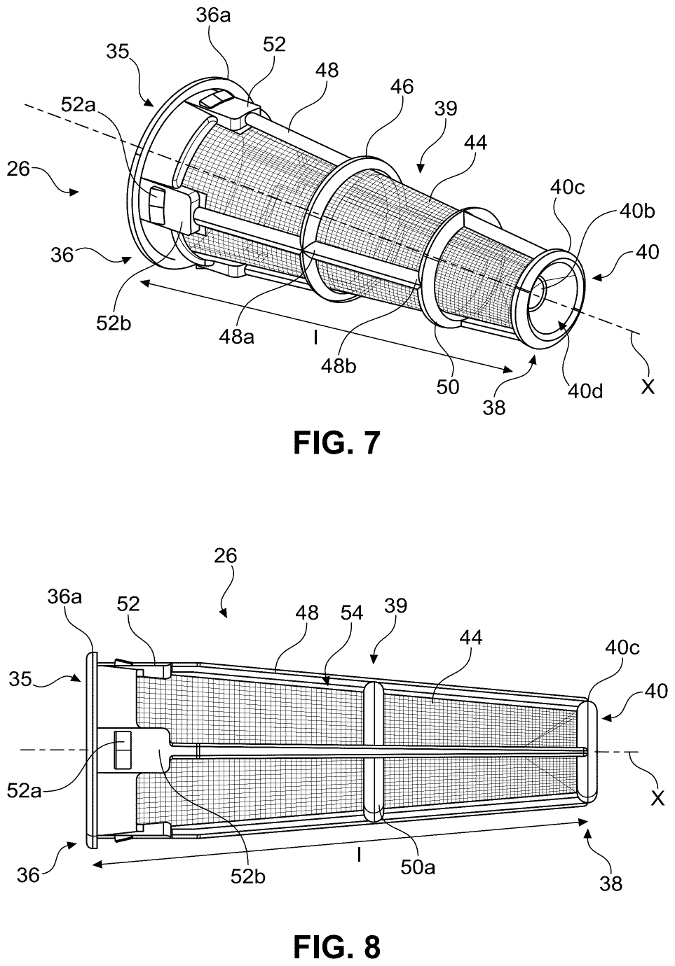

FIG. 7 illustrates a second embodiment of the filter 26. The entire description of FIGS. 1 to 6 applies to the second embodiment. Only the differences are described below.

The filter 26 of the FIG. 7 differs from the filter 26 of the first embodiment described above in that the longitudinal ribs 48 extend discontinuously between the first and second ends 36, 38 of the filter 26. According to this second embodiment, each longitudinal rib 48 has a first end 48a connected to an annular rib 50 and a second end 48b connected to another adjacent annular rib 50. The longitudinal ribs 48 can be axially aligned or misaligned.

The longitudinal ribs 48 may be evenly or irregularly distributed around the longitudinal axis X.

In addition, according to this embodiment, the filter 26 has four annular ribs 50 evenly distributed along the longitudinal axis X, the annular ribs 50 located at the ends forming the external annular shoulder 36a and the annular rim 40c respectively.

FIG. 8 illustrates a third embodiment of the filter 26. The entire description of FIGS. 1 to 6 applies to the third embodiment. Only the differences are described below.

The filter 26 in FIG. 8 differs from the filter 26 in the first embodiment in that the longitudinal ribs 46 are fixed to the annular ribs 50a and in that a radial space 54 is provided between the filter mesh 44 and each longitudinal rib 46. In this design, only the annular ribs 50 are overmolded onto the filter mesh 44.

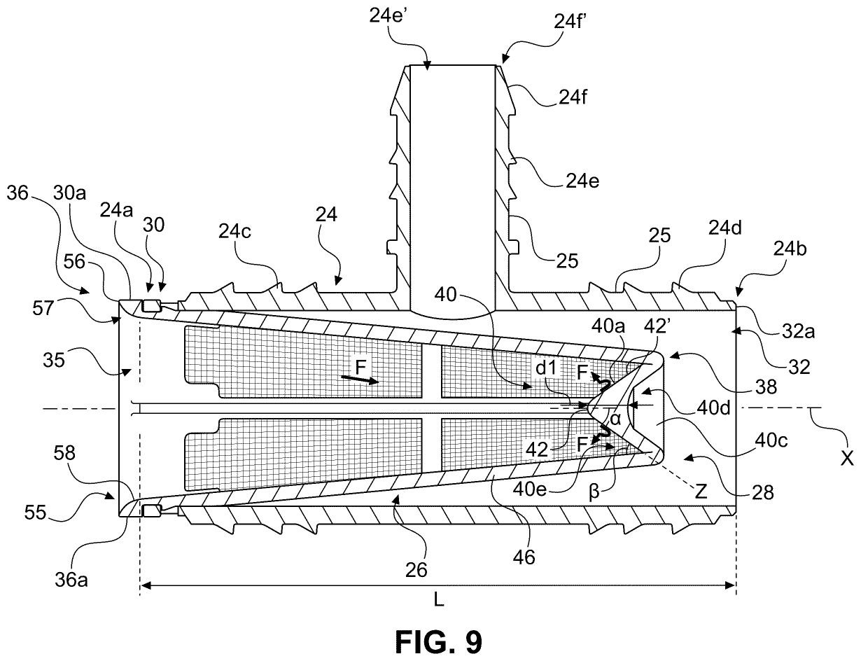

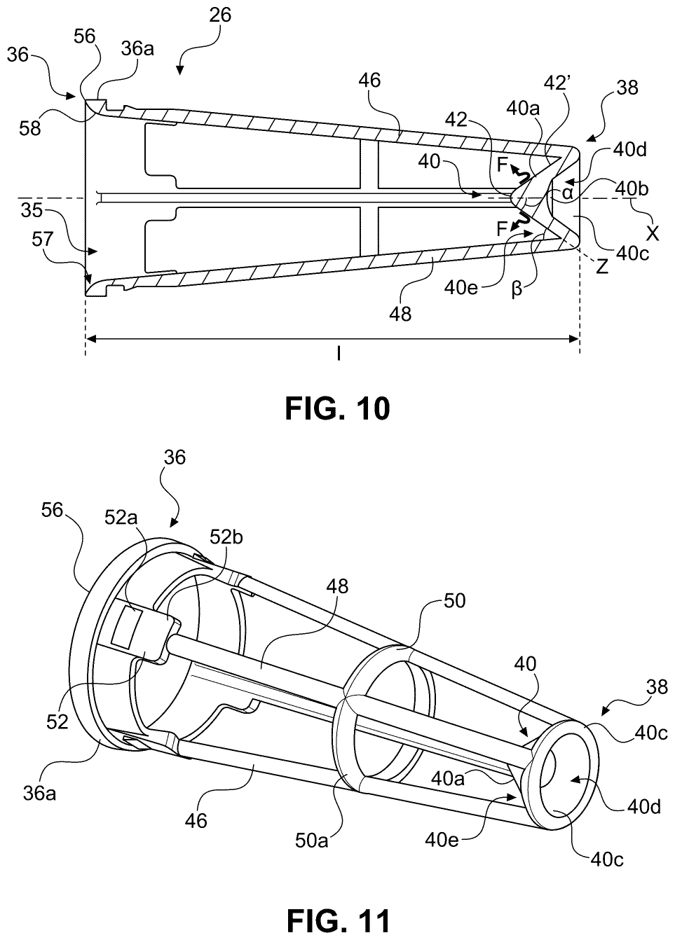

FIGS. 9 to 11 illustrate one embodiment of the invention. The entire description of FIGS. 1 to 8 applies to this embodiment.

The filter 26 has an inlet 55 of the fluid F located on the side of the first longitudinal end 36 and therefore opposite the bottom wall 40. The inlet 55 is supported by the connector 24. The inlet 55 may be formed by the shoulder or the lip 36a.

The inlet 55 is annular and centred on the longitudinal axis X.

The inlet 55 has a generally flared shape towards the first longitudinal end and towards the outside of the filter 26, therefore away from the longitudinal axis X.

The inlet 55 has a free peripheral edge 56 and an internal surface 57. The internal surface 57 has a rounded shape 58. The rounded shape 58 extends to the peripheral edge 56 of the inlet 55. The rounded shape 58 preferably has a radius of between 2 mm and 10 mm, and even more preferably between 3 mm and 5 mm.

The inlet 55 is integral with the body 46 of the filter 26.

The inlet 55 of the filter 26, with its rounded shape 58, allows the disturbances of the flow of the fluid to be limited. In addition, the inlet 55 is formed directly on the body 46 of the filter 26 so that no additional parts are required to form the inlet of the filter.

1. A filtration device, in particular for a cooling circuit, the filtration device comprising:
a tubular connector comprising at least one cooling fluid inlet and at least an outlet of this cooling fluid,
a particulate filter mounted in said connector and extending into the connector from said inlet, said filter having a generally elongate shape and comprising a first open longitudinal end located on the side of said inlet and a second closed longitudinal end located inside the connector, this filter comprising a filter mesh extending around and along a longitudinal axis (X) of the filter, and an overmolded body,
characterised in that the filter is removably mounted in said connector and in that said second end has a bottom wall which converges towards the longitudinal axis (X) and towards said first longitudinal end.

2. The filtration device according to claim 1, characterised in that the bottom wall comprises a conical or frustoconical surface which is located inside the filter and which has an apex centred on the longitudinal axis.

3. The filtration device according to claim 1, characterised in that said conical or frustoconical surface has a generatrix forming an angle with the longitudinal axis of between 10° and 45°.

4. The filtration device according to claim 1, characterised in that the first longitudinal end has a first diameter and said second longitudinal end has a second diameter, the first diameter being greater than the second diameter, preferably from 1.5 times to four times greater than the second diameter.

5. The filtration device according to claim 1, characterised in that the bottom wall has a longitudinal dimension along said longitudinal axis, which represents between 2% and 20%, and preferably between 5% and 10%, of a length of the filter along this longitudinal axis.

6. The filtration device according to claim 1, characterised in that the filter comprises a frustoconical filtration wall at which the filter mesh is located, the bottom wall being connected to this filtration wall by an annular rim located at the second longitudinal end of the filter.

7. The filtration device according to the claim 1, characterised in that the bottom wall defines, outside the filter, a recess which is centred on said longitudinal axis and which is surrounded by said annular rim.

8. The filtration device according to claim 7, characterised in that the recess comprises at least one material injection point.

9. The filtration device according to claim 8, characterised in that the recess has a frustoconical surface, one end of which, having a smaller diameter, is connected to a surface substantially perpendicular to said longitudinal axis.

10. The filtration device according to claim 9, characterised in that an end of greater diameter of the frustoconical surface is connected to said annular rim.

11. The filtration device according to claim 10, characterised in that the first longitudinal end has an external annular shoulder bearing axially on an annular edge of the inlet of the connector.

12. The filtration device according to claim 1, characterised in that the filter is snap-fitted into said connector.

13. The filtration device according to claim 12, characterised in that the first longitudinal end has at its external periphery at least one fixing tab, and the connector has at least one opening into which the tab is snap-fitted.

14. The filtration device according to claim 1, characterised in that the body comprises longitudinal ribs, and advantageously annular ribs overmolded onto the filter mesh and which extend around the longitudinal axis and are connected to said longitudinal ribs.

15. The filtration device according to claim 13, characterised in that the number of tabs is equal to the number of longitudinal ribs and the tabs are axially aligned with the longitudinal ribs or are located on these longitudinal ribs.

16. The filtration device according to claim 1, characterised in that the filter has a length such that it extends over more than 80% of the length of the connector.

17. The filtration device according to claim 1, characterised in that the filter mesh and the body comprise a polymeric material, advantageously identical and chosen for example from polyamides.

18. The filtration device according to claim 1, characterised in that the filter mesh comprises a textile, preferably woven.

19. The filtration device according to claim 1, characterised in that the filter mesh has a filtration surface of between 60% and 95%, preferably between 70% and 80%, of a total external surface of the filter.

20. The filtration device according to claim 1, characterised in that the filter comprises an inlet opposite the second longitudinal end, the inlet having a rounded shape.

21. The cooling circuit for an engine, characterised in that it comprises at least one filtration device according to claim 1.
